(19) United States
(12) Patent Application Publication
(10) Pub. No.: US 2014/0313544 A1
(43) Pub. Date: Oct. 23, 2014

(54) PRINTING SYSTEM, SERVER, INFORMATION PROCESSING APPARATUS, IMAGE PROCESSING APPARATUS, PRINTING CONTROL METHOD AND STORAGE MEDIUM STORING PROGRAM

(71) Applicant: CANON KABUSHIKI KAISHA, Tokyo (JP)

(72) Inventor: Kazuhide Hasegawa, Yokohama-shi (JP)

(21) Appl. No.: 14/246,410

(22) Filed: Apr. 7, 2014

(30) Foreign Application Priority Data
Apr. 19, 2013 (JP) 2013-088877

(51) Int. Cl. G06F 3/12

(52) U.S. Cl. CPC G06F 3/1237; G06F 3/1288
USPC 358/1.15

(57) ABSTRACT

In a printing system, print data for executing printing by performing a composition with registered form data, and form data to be registered for the printing are associated and held. In a case where an instruction to print the print data is accepted, it is controlled to register the form data and then execute printing of the print data.

### BACKGROUND OF THE INVENTION

1. Field of the Invention

The present invention relates to a printing system, server, information processing apparatus, image processing apparatus, printing control method for printing based on a print job and a storage medium storing program.

2. Description of the Related Art

There is known a technique of temporarily reserving print data in a server on a network (so-called reservation printing), performing user authentication in an arbitrary output destination printer, and then performing pull print, as disclosed in Japanese Patent Laid-Open No. 2011-81741.

There is also known a technique of generating, by a PDL command, resource data such as a form, macro, font, or color profile, which is repetitively used in a plurality of print data, then setting the resource data as PDL print data, and registering the resource data.

However, in a printing system disclosed in Japanese Patent Laid-Open No. 2011-81741, resource data is also treated (forcibly reserved) like print data. As for resource data and print data into which the resource data should be reflected, no correct output result is obtained unless the resource data is processed first and then the print data is processed.

In a document list, however, both resource registration data and print data are displayed as normal documents. It is difficult for the user to identify resource registration data or print data in the document list. It is therefore hard to process resource registration data and print data in a correct order.

### SUMMARY OF THE INVENTION

An aspect of the present invention is to eliminate the above-mentioned problems with the conventional technology. The present invention provides a printing system, server, information processing apparatus, image processing apparatus, and printing control method for appropriately executing form printing, and a storage medium storing a program.

The present in one aspect provides a printing system comprising: a holding unit configured to associate print data with form data and hold the print data and the form data; an acceptance unit configured to accept an instruction to print the print data; and a print control unit configured to, in a case where the acceptance unit accepts the instruction, control to register the form data and then execute printing of the print data.

According to the present invention, form printing can be executed appropriately.

Further features of the present invention will become apparent from the following description of exemplary embodiments with reference to the attached drawings.

### BRIEF DESCRIPTION OF THE DRAWINGS

FIG. 1 is a view showing an outline of the overall arrangement of a printing system;

FIG. 2 is a block diagram for explaining the hardware arrangement of an information processing apparatus;

FIG. 3 is a block diagram for explaining the hardware arrangement of a server;

FIG. 4 is a block diagram for explaining the hardware arrangement of an image processing apparatus;

FIG. 5 is a block diagram for explaining the software arrangement of the printing system;

FIG. 6 is a sequence chart showing job data registration processing in the printing system;

FIG. 7 is a sequence chart showing pull print processing in the printing system;

FIG. 8 is a flowchart showing the procedures of screen display processing in form data registration;

FIG. 9 is a view showing an example of a warning screen in form data registration;

FIG. 10 is a flowchart showing the procedures of data generation processing in form data registration;

FIG. 11 is a table showing an example of a bibliographic information list managed by the server;

FIGS. 12A and 12B are views showing examples of a print data list screen;

FIG. 13 is a flowchart showing the procedures of pull print processing in the image processing apparatus;

FIG. 14 is a block diagram showing another form of the software arrangement of the server;

FIG. 15 is a sequence chart showing enterprise job data registration processing;

FIG. 16 is a flowchart showing the procedures of enterprise job data registration processing;

FIG. 17 is a sequence chart showing pull print processing in which form data is transmitted simultaneously;

FIGS. 18A and 18B are views showing examples of form registration data generated by the information processing apparatus; and

FIGS. 19A and 19B are views showing examples of form registration PDL data generated by an enterprise server.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals denote the same parts, and a repetitive description thereof will be omitted.

### First Embodiment

### [System Arrangement]

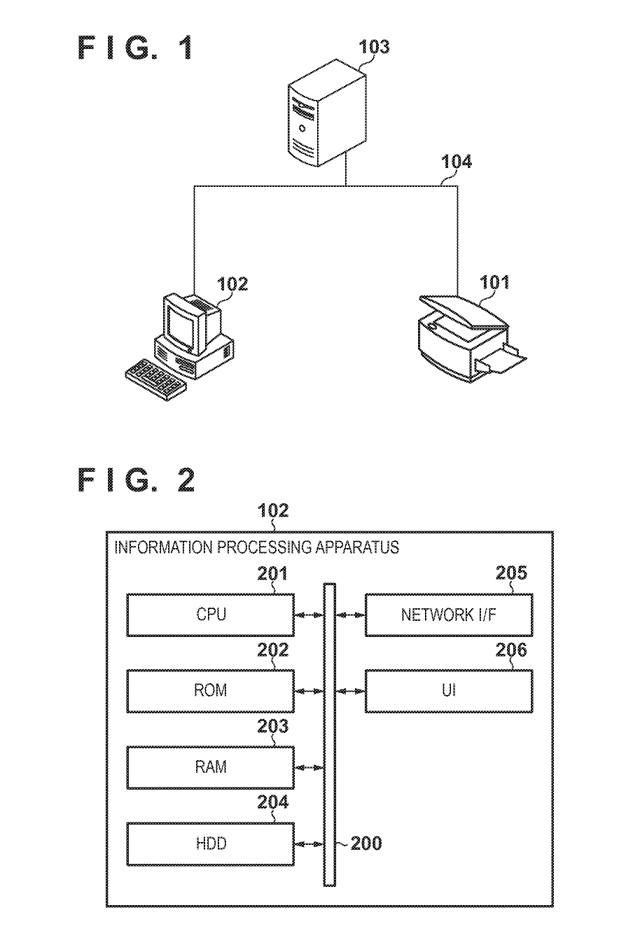

FIG. 1 is a view showing an outline of the overall arrangement of a printing system. In FIG. 1, an image processing apparatus 101 is connected to an information processing apparatus 102 and a bibliographic information server (to be simply referred to as a server hereinafter) 103 via a network 104 so that they can communicate with each other. As each of the information processing apparatus 102 and server 103, for example, a general-purpose PC including a CPU, display, keyboard, pointing device, hard disk drive (HDD), memory, and network communication interface is usable. The image processing apparatus 101 is an MFP (MultiFunctional Peripheral) capable of executing multiple functions such as an electronic document print function, hard copy function, and facsimile communication function. The information processing apparatus 102 generates job data with which the image processing apparatus 101 can execute printing, and transmits it to the server 103.

The server 103 holds and manages job data received from the information processing apparatus 102, and also manages bibliographic information of the job data. The bibliographic information includes, for the job data, information of a user who input job data, document information, and information of the date and time when the job data was input (registered) to the server 103. The bibliographic information will also be called job information hereinafter. The image processing apparatus 101 acquires a bibliographic information list from the server 103, and displays it on the display of the image processing apparatus 101. The user can select job data he wants from the bibliographic information list displayed on the display, preview it, and change print settings. After that, the image processing apparatus 101 acquires the job data selected by the user from the server 103, and prints it out.

### [Arrangement of Each Apparatus]

FIG. 2 is a block diagram for explaining the hardware arrangement of the information processing apparatus 102. The information processing apparatus 102 includes a CPU 201, ROM 202, RAM 203, HDD 204, network I/F 205, and operation unit (UI) 206. These blocks are connected via an internal bus 200 so that they can communicate with each other. The CPU 201 performs centralized control of the information processing apparatus 102, and implements an operation according to each embodiment by reading out various programs stored in the ROM 202 or HDD 204 to the RAM 203 and executing them. The RAM 203 is used as a work memory necessary to operate the CPU 201. The RAM 203 is also used as a memory for temporarily storing various data. The HDD 204 stores programs and various data before loading them to the RAM 203. The network I/F 205 connects the information processing apparatus 102 to the network 104. The network I/F 205 allows the information processing apparatus 102 to communicate with the image processing apparatus 101 and server 103. The UI 206 includes a display, keyboard, and the like (none of them are shown). The UI 206 can accept various operation instructions from the user, and display various statuses of the information processing apparatus 102.

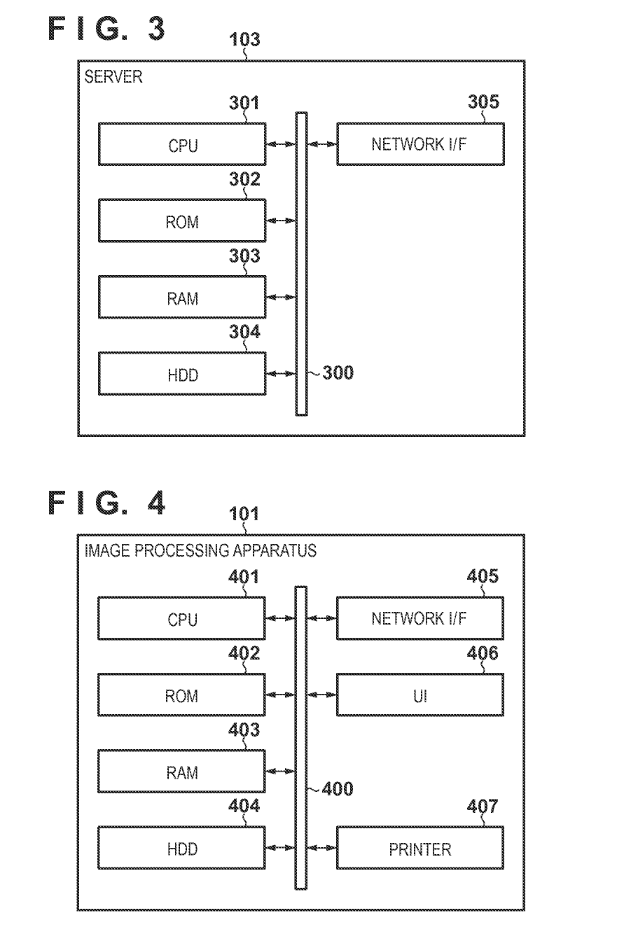

FIG. 3 is a block diagram for explaining the hardware arrangement of the server 103. The server 103 includes a CPU 301, ROM 302, RAM 303, HDD 304, and network I/F 305. These blocks are connected via an internal bus 300 so that they can communicate with each other. The CPU 301 performs centralized control of the server 103, and implements an operation according to each embodiment by reading out various programs stored in the ROM 302 or HDD 304 to the RAM 303 and executing them. The RAM 303 is used as a work memory necessary to operate the CPU 301. The RAM 303 is also used as a memory for temporarily storing various data. The HDD 304 stores programs and various data before loading them to the RAM 303. The network I/F 305 connects the server 103 to the network 104. The network I/F 305 allows the server 103 to communicate with the image processing apparatus 101 and information processing apparatus 102.

FIG. 4 is a block diagram for explaining the hardware arrangement of the image processing apparatus 101. The image processing apparatus 101 includes a CPU 401, ROM 402, RAM 403, HDD 404, network I/F 405, and UI 406. These blocks are connected via an internal bus 400 so that they can communicate with each other. The CPU 401 performs centralized control of the image processing apparatus 101, and implements an operation according to each embodiment by reading out various programs stored in the ROM 402 or HDD 404 to the RAM 403 and executing them. The RAM 403 is used as a work memory necessary to operate the CPU 401. The RAM 403 is also used as a memory for temporarily storing various data. The HDD 404 stores programs and various data before loading them to the RAM 403. The network I/F 405 connects the image processing apparatus 101 to the network 104. The network I/F 405 allows the image processing apparatus 101 to communicate with the information processing apparatus 102 and server 103. The UI 406 includes various buttons, touch panel, and the like (none of them are shown). The UI 406 can accept various operation instructions from the user, and display various statuses of the image processing apparatus 101. A printer 407 is an image output apparatus which prints target image data on a printing medium such as printing paper by various printing methods such as an inkjet printing method.

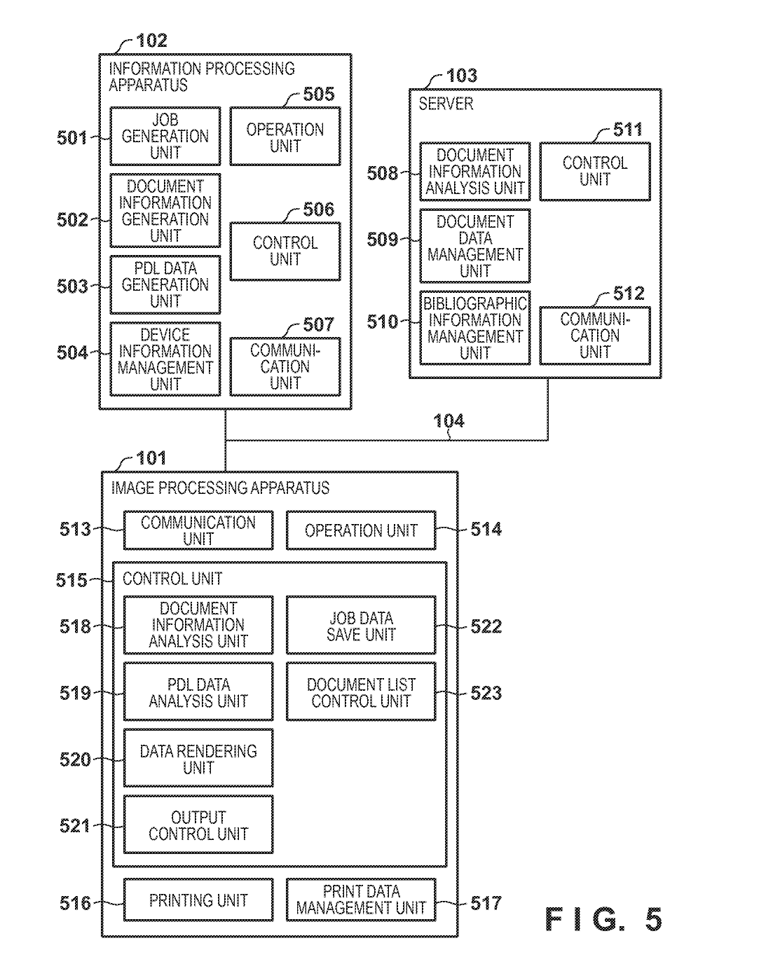

FIG. 5 is a block diagram for explaining the software arrangement of the printing system. The respective processing functions of the information processing apparatus 102 are implemented by executing programs stored in the ROM 202 by the CPU 201. The processing functions to be executed by the CPU 201 include a job generation unit 501, document information generation unit 502, PDL data generation unit 503, device information management unit 504, operation unit 505, control unit 506, and communication unit 507. The job generation unit 501 generates job data from document information generated by the document information generation unit 502 and PDL data generated by the PDL data generation unit 503. The document information generation unit 502 generates document information serving as the job attribute of job data. The PDL data generation unit 503 generates PDL data serving as a data format with which the image processing apparatus 101 can execute printing. The device information management unit 504 stores device information in the HDD 204 and manages it. The operation unit 505 can accept various operation instructions from the user via the UI 206, and display various statuses of the information processing apparatus 102 on the UI 206. The control unit 506 performs various control operations of job data. The communication unit 507 communicates with an apparatus on the network 104 via the network I/F 205.

Various processing functions of the server 103 are implemented by executing programs stored in the ROM 302 by the CPU 301. The processing functions to be executed by the CPU 301 include a document information analysis unit 508, document data management unit 509, bibliographic information management unit 510, control unit 511, and communication unit 512. The document information analysis unit 508 analyzes document information of job data transmitted from the information processing apparatus 102. The document data management unit 509 stores, in the HDD 304, job data transmitted from the information processing apparatus 102, and manages it. The bibliographic information management unit 510 stores, in the HDD 304, bibliographic information of the job data managed by the document data management unit 509, and manages it. The control unit 511 performs various control operations of job data. The communication unit 512 communicates with an apparatus on the network 104 via the network I/F 305.

Various processing functions of the image processing apparatus 101 are implemented by executing programs stored in the ROM 402 by the CPU 401. The processing functions to be executed by the CPU 401 include a communication unit 513, operation unit 514, control unit 515, printing unit 516, and print data management unit 517. The operation unit 514 can accept various operation instructions from the user via the UI 406, and display various statuses of the image processing apparatus 101 on the UI 406. The control unit 515 performs various control operations of job data. The communication unit 513 communicates with an apparatus on the network 104 via the network I/F 405. The printing unit 516 forms an image based on an image signal to the printer 407, and prints it out. The print data management unit 517 stores, in the HDD 404, image data bitmap-converted from each page of job data by the control unit 515, and manages it.

The control unit 515 includes a document information analysis unit 518, PDL data analysis unit 519, data rendering unit 520, output control unit 521, job data save unit 522, and document list control unit 523. The document information analysis unit 518 analyzes each job attribute of job data. The PDL data analysis unit 519 analyzes each page data of job data and converts it into intermediate data (for example, a display list). The PDL data analysis unit 519 stores, accumulates, and saves the converted intermediate data in the job data save unit 522 within the RAM 403. The data rendering unit 520 converts the accumulated/saved intermediate data into bitmap data of each page, and accumulates and saves the bitmap data in the print data management unit 517. The output control unit 521 converts bitmap data of each page into a video signal, and performs image transfer processing in synchronism with the image forming and paper feed operations of the printing unit 516. The job data save unit 522 temporarily saves intermediate data converted by the PDL data analysis unit 519. The document list control unit 523 controls display of a document list on the display unit (not shown) of the operation unit 514 from a bibliographic information list acquired from the server 103.

### [Job Data Registration Processing]

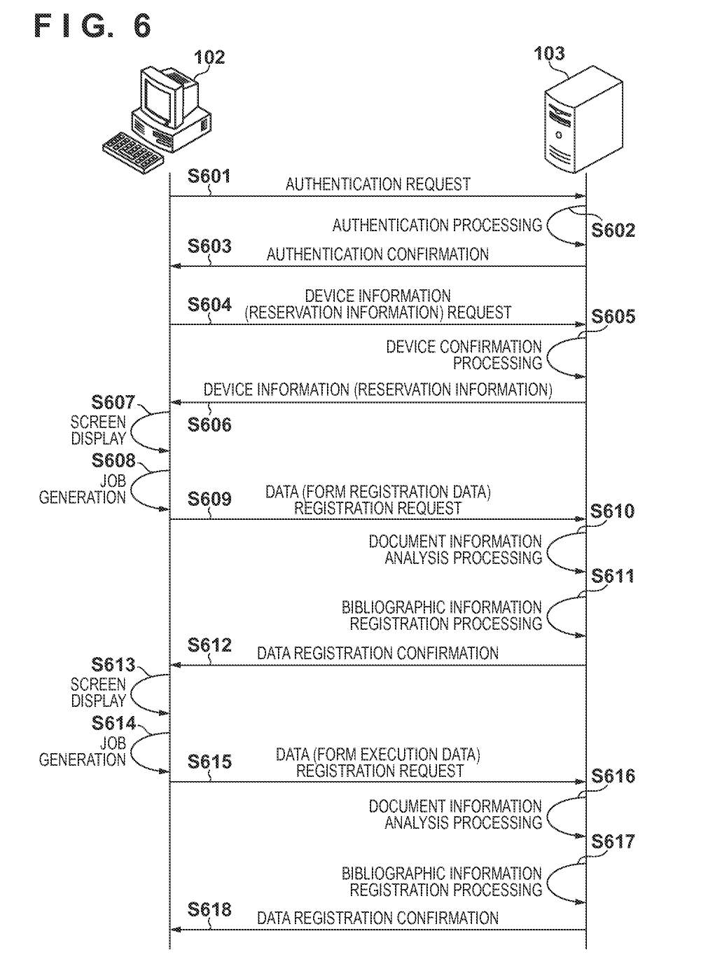

FIG. 6 is a sequence chart showing job data registration processing in the printing system. When the information processing apparatus 102 accepts an instruction via the operation unit 505 to register data of a print job designated by the user, it notifies the control unit 506 to start data registration. Upon accepting the data registration start notification, the control unit 506 generates an authentication request, and transmits an authentication request to the server 103 via the communication unit 507 (step S601).

If the server 103 receives the authentication request from the information processing apparatus 102 via the communication unit 512, the control unit 511 performs authentication processing (step S602). If the control unit 511 accepts the authentication request, the server 103 transmits an authentication confirmation to the information processing apparatus 102 via the communication unit 512 (step S603). If the information processing apparatus 102 receives the authentication confirmation from the server 103, the control unit 506 generates a device information acquisition request, and transmits the device information acquisition request to the server 103 via the communication unit 507 (step S604). If the server 103 receives the device information acquisition request from the information processing apparatus 102 via the communication unit 512, the control unit 511 confirms device information (step S605).

The device information is processing ability information for a print job and includes, for example, print settings such as the color mode, and the job forcible reservation setting. The job forcible reservation is so-called reservation printing. In reservation printing, first, the user registers a print job he wants in a server from an information processing apparatus together with target print data. At this time, no printing is executed. When the user requires a printout, he goes to an image processing apparatus, performs an authentication operation, and if necessary, designates the print job. In response to this, the image processing apparatus acquires print data from the server and executes printing.

If the control unit 511 completes the device information confirmation processing, the server 103 transmits the device information to the information processing apparatus 102 via the communication unit 512 (step S606). If the information processing apparatus 102 receives the device information from the server 103, it saves the device information in the device information management unit 504. In accordance with the device information, the information processing apparatus 102 displays various screens for generating a print job (step S607).

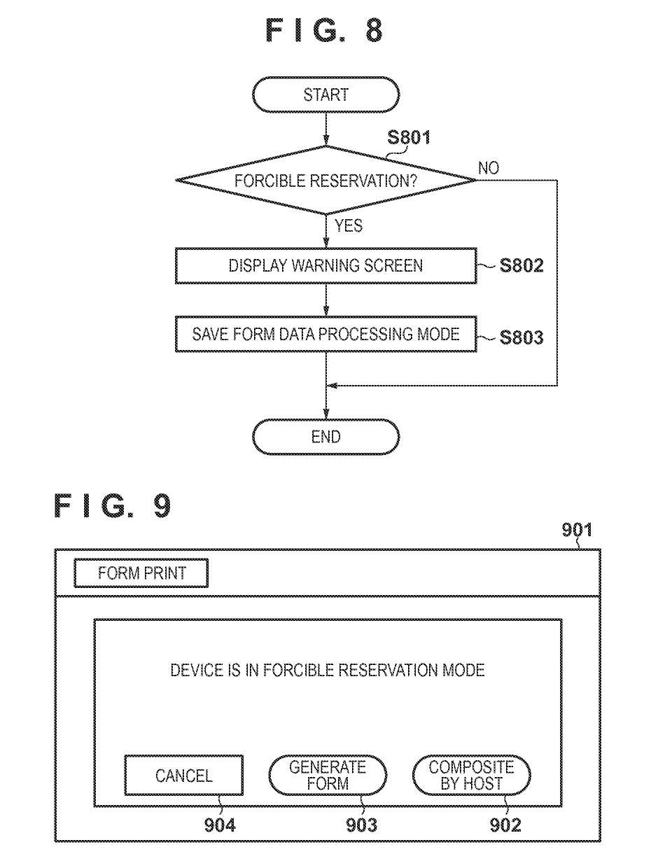

FIG. 8 is a flowchart showing procedures to display a screen in the information processing apparatus 102 in form data registration. This flowchart is implemented by executing a program stored in the ROM 202 by the CPU 201. The control unit 506 reads out device information from the device information management unit 504. The control unit 506 determines whether the job forcible reservation mode is set (step S801). If the control unit 506 determines that the job forcible reservation mode is set, it sends a warning notification to the operation unit 505. Upon receiving the warning notification, the operation unit 505 displays a warning screen (step S802), and then the process advances to step S803. If the control unit 506 determines that the job forcible reservation mode is not set, the processing of FIG. 8 ends without displaying a warning screen. In step S803, the control unit 506 temporarily saves, in the RAM 203, a form data processing mode selected on the warning screen.

FIG. 9 is a view showing an example of a warning screen displayed in the information processing apparatus 102 in form data registration. As shown in FIG. 9, a warning screen 901 includes a message which calls user's attention, a “composite by host” button 902 and “generate form” button 903 for prompting the user to select the form data processing mode, and a “cancel” button 904 for interrupting print processing. When the user selects the “composite by host” button 902, the information processing apparatus 102 generates PDL data by compositing form data and page data to normal print data by the PDL data generation unit 503. When the user selects the “generate form” button 903, the information processing apparatus 102 generates PDL data by using form data as form registration data by the PDL data generation unit 503. The generated form registration data is resource data which can be repetitively used in each page of form execution data or a plurality of form execution data (to be described later).

Referring again to FIG. 6, in the information processing apparatus 102, the job generation unit 501 generates designated job data (step S608). As the form data processing mode, form registration data is generated. Since the form data processing mode is form registration, the document information generation unit 502 generates form registration information as document information.

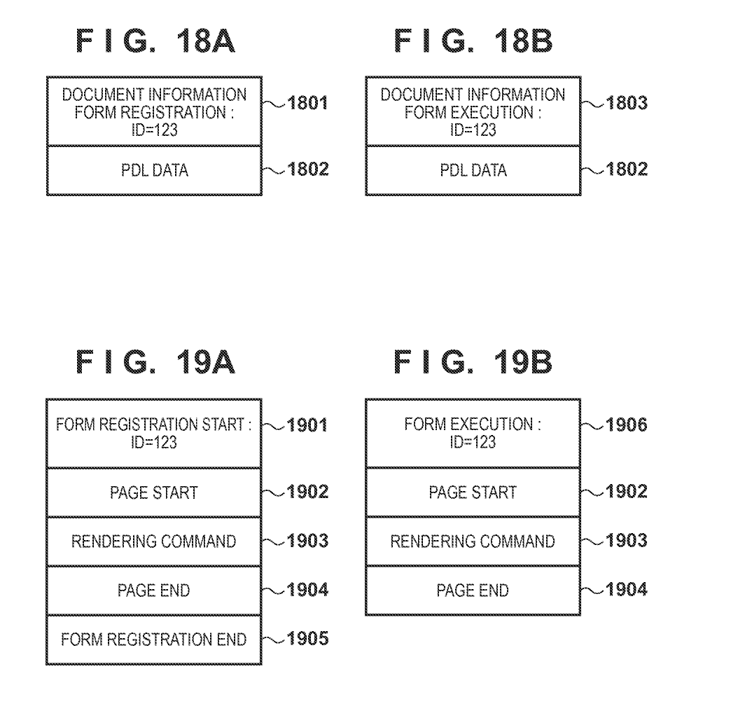

FIG. 18A is a view showing an example of form registration data generated by the information processing apparatus 102. As shown in FIG. 18A, document information 1801 describes identification information representing form registration data, and a form ID to be registered. PDL data 1802 describes form registration PDL data.

If the job generation unit 501 generates designated job data, the information processing apparatus 102 transmits the designated job data to the server 103 via the communication unit 507, and issues a data registration request (step S609).

If the server 103 receives the job data from the information processing apparatus 102, the document information analysis unit 508 analyzes document information of the received job data (step S610). Then, the bibliographic information management unit 510 registers bibliographic information from the analyzed document information. In addition, the document data management unit 509 registers the received job data (step S611). At this time, bibliographic information is saved as a form registration job in the bibliographic information management unit 510 from form registration information of the document information. If the bibliographic information management unit 510 registers the bibliographic information of the received job data, the server 103 transmits a registration confirmation for the designated job data to the information processing apparatus 102 (step S612).

The information processing apparatus 102 generates form execution data which is output while being composited with registered form data in printing. First, the information processing apparatus 102 displays various screens for generating a print job (step S613). Because of normal printing, a warning screen in form registration is not displayed. Then, in the information processing apparatus 102, the job generation unit 501 generates designated job data (step S614). As the form data processing mode, form execution data is generated. Since the form data processing mode is form execution, the document information generation unit 502 generates form execution information as document information.

FIG. 18B is a view showing an example of form execution data generated by the information processing apparatus 102. In FIG. 18B, document information 1803 describes identification information representing form execution data, and a form ID to be executed. The PDL data 1802 describes form execution PDL data. If the job generation unit 501 generates designated job data, the information processing apparatus 102 transmits the designated job data to the server 103 via the communication unit 507, and issues a data registration request (step S615).

If the server 103 receives the job data from the information processing apparatus 102, the document information analysis unit 508 analyzes document information of the received job data (step S616). Then, the bibliographic information management unit 510 registers bibliographic information from the analyzed document information. Also, the document data management unit 509 registers the received job data (step S617). At this time, bibliographic information is saved as a form execution job in the bibliographic information management unit 510 from form execution information of the document information. If the bibliographic information management unit 510 registers the bibliographic information of the received job data, the server 103 transmits a registration confirmation for the designated job data to the information processing apparatus 102 (step S618). If the information processing apparatus 102 receives the registration confirmation for the designated job data from the server 103, it ends the print job data registration processing.

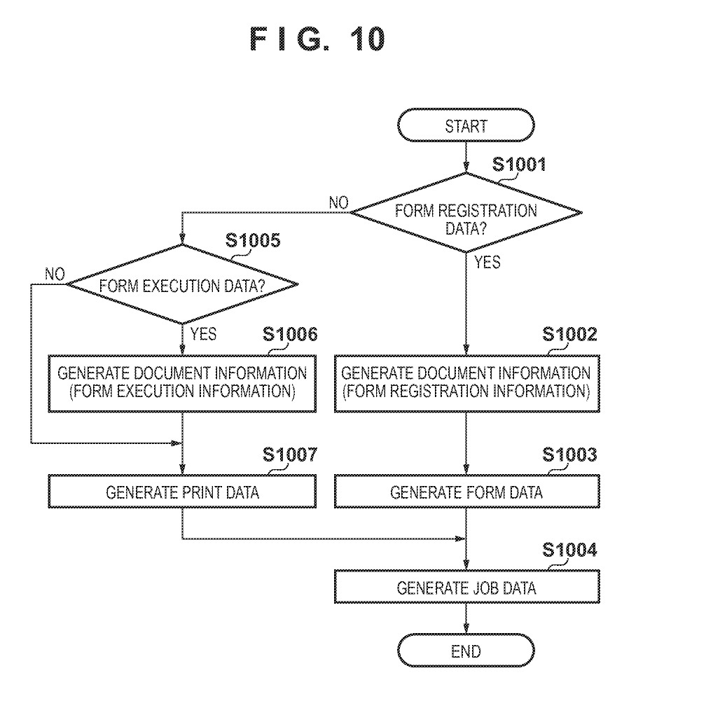

FIG. 10 is a flowchart showing the procedures of data generation processing in the information processing apparatus 102 in form data registration. This flowchart is implemented by executing a program stored in the ROM 202 by the CPU 201. The job generation unit 501 determines a form data processing mode temporarily saved in step S803, and if the form data processing mode is the form generation mode with forcible reservation, performs the processing in FIG. 10.

First, the job generation unit 501 determines whether the form data processing mode is form registration data (step S1001). If the job generation unit 501 determines that the form data processing mode is form registration data, it notifies the document information generation unit 502 of form registration identification information. The document information generation unit 502 generates document information from the form registration identification information (step S1002). Then, the PDL data generation unit 503 generates form registration PDL data (step S1003). The job generation unit 501 generates job data from the document information generated by the document information generation unit 502 and the PDL data generated by the PDL data generation unit 503 (step S1004).

If the job generation unit 501 determines in step S1001 that the form data processing mode is not form registration data, it determines whether the form data processing mode is form execution data (step S1005). If the job generation unit 501 determines that the form data processing mode is form execution data, it notifies the document information generation unit 502 of form execution identification information. The document information generation unit 502 generates document information from the form execution identification information (step S1006). Then, the PDL data generation unit 503 generates form execution PDL data (step S1007).

If the job generation unit 501 determines in step S1005 that the form data processing mode is not form execution data, the PDL data generation unit 503 generates normal print PDL data. This processing is executed when the form data processing mode is host composition data, that is, when the “composite by host” button 902 is pressed.

### [Example of Bibliographic Information List Managed by Server]

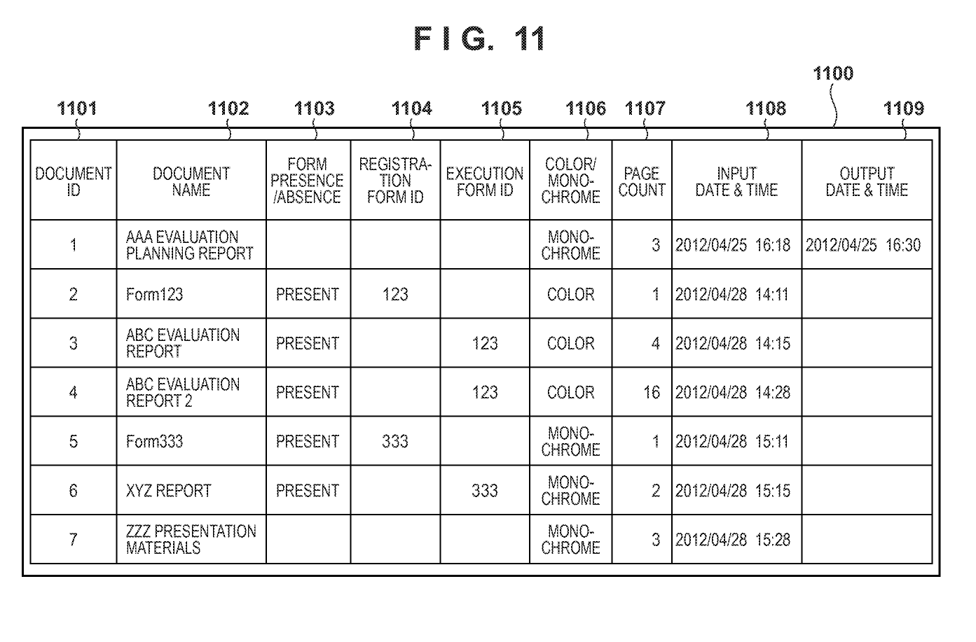

FIG. 11 is a table showing an example of a bibliographic information list managed by the server 103. A bibliographic information list 1100 manages a document ID 1101, document name 1102, form presence/absence flag 1103, registration form ID 1104, and execution form ID 1105 of job data. Also, the bibliographic information list 1100 manages a color mode 1106, page count 1107, input date & time 1108, and output date & time 1109. The document ID 1101, document name 1102, form presence/absence flag 1103, registration form ID 1104, execution form ID 1105, color mode 1106, and page count 1107 are managed based on document information of job data received from the information processing apparatus 102. The input date & time 1108 is the date & time when job data was received from the information processing apparatus 102. The output date & time 1109 is the date & time when a bibliographic information update request was received as a printout completion notification from the image processing apparatus 101 after outputting job data.

In this example, document data of the document ID 1101=“2” is managed as a form registration job (form data), and the form presence/absence flag 1103 and the registration form ID 1104=“123” are saved. Further, document data of the document ID 1101=“3”, “4” are managed as form execution jobs (data to be composited with a form and printed), and the form presence/absence flag 1103 and the execution form ID 1105=“123” are saved.

With this arrangement, a form registration job and form execution job can be associated from bibliographic information and processed. The form presence/absence flag 1103 can easily identify a formation registration, form execution job, or normal print job.

### [Pull Print Processing]

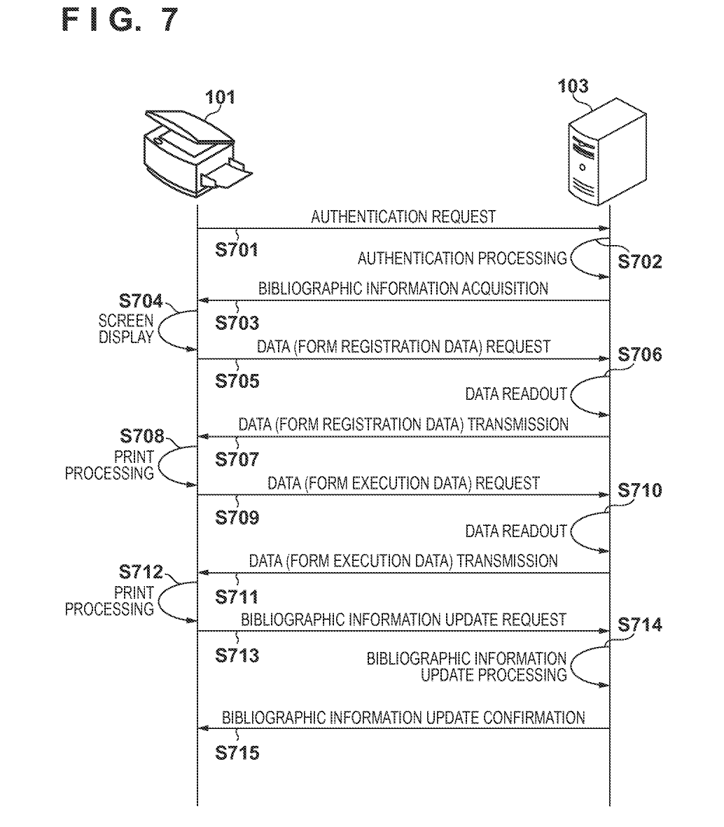

FIG. 7 is a sequence chart showing pull print processing in the printing system. When the image processing apparatus 101 accepts the start of an operation (pull print) for registered data from the user via the operation unit 514, it notifies the control unit 515 to start the operation. Upon accepting the operation start notification, the control unit 515 generates an authentication request, and transmits it to the server 103 via the communication unit 513 (step S701).

If the server 103 receives the authentication request from the image processing apparatus 101 via the communication unit 512, the control unit 511 performs authentication processing (step S702). If the control unit 511 accepts the authentication request, the server 103 transmits a bibliographic information list to the image processing apparatus 101 via the communication unit 512 (step S703).

If the image processing apparatus 101 receives the bibliographic information list from the server 103, the operation unit 514 displays a print data list based on the bibliographic information list (step S704). If the operation unit 514 accepts an instruction from the user to print out arbitrary job data, the image processing apparatus 101 issues a data transmission request for the job data to the server 103 via the communication unit 513 (step S705). Here, the user instructs the image processing apparatus 101 to print out form execution data. In this case, the image processing apparatus 101 automatically issues a data transmission request for form registration data based on the form execution data printout instruction.

If the server 103 receives the data transmission request for the job data from the image processing apparatus 101, the document data management unit 509 reads out the designated job data (step S706). If the document data management unit 509 completes the readout of the designated job data, the server 103 transmits the designated job data to the image processing apparatus 101 via the communication unit 512 (step S707).

If the image processing apparatus 101 receives the designated job data from the server 103 via the communication unit 513, the control unit 515 performs print processing for the job data (step S708). Since the image processing apparatus 101 receives form registration data as the job data, the PDL data analysis unit 519 generates intermediate data from the received form registration data. The image processing apparatus 101 temporarily saves the generated intermediate data in the job data save unit 522.

The image processing apparatus 101 issues a data transmission request for form execution data to the server 103 via the communication unit 513 (step S709). If the server 103 receives the data transmission request for the form execution data from the image processing apparatus 101, the document data management unit 509 reads out the designated form execution data (step S710).

If the document data management unit 509 completes the readout of the designated form execution data, the server 103 transmits the designated form execution data to the image processing apparatus 101 via the communication unit 512 (step S711).

If the image processing apparatus 101 receives the designated form execution data from the server 103 via the communication unit 513, the control unit 515 performs print processing for the form execution data (step S712). Since the image processing apparatus 101 receives form execution data as the job data, the PDL data analysis unit 519 generates intermediate data from the received form execution data.

The image processing apparatus 101 temporarily saves the generated intermediate data in the job data save unit 522. In the image processing apparatus 101, the data rendering unit 520 composites the temporarily saved form intermediate data and print intermediate data, and converts the composited data into an output image. The output control unit 521 and printing unit 516 perform printout of the received job data.

After that, the image processing apparatus 101 transmits a bibliographic information update request to the server 103 to notify that the printout of the received job data has been completed (step S713). If the server 103 receives the bibliographic information update request for arbitrary job data from the image processing apparatus 101 via the communication unit 512, the bibliographic information management unit 510 updates bibliographic information of the designated job data (step S714). In response to the bibliographic information update request, the output date & time 1109 in the bibliographic information list 1100 is updated. An image processing apparatus which printed out may be described and managed in the bibliographic information list so that identification information of the image processing apparatus which printed out can be updated.

If the bibliographic information management unit 510 updates the bibliographic information of the designated job data, the server 103 transmits a bibliographic information update confirmation for the designated job data to the image processing apparatus 101 (step S715). If the image processing apparatus 101 receives the bibliographic information update confirmation for the designated job data from the server 103, the pull print processing ends.

### [Print Data List Screen Displayed by Image Processing Apparatus]

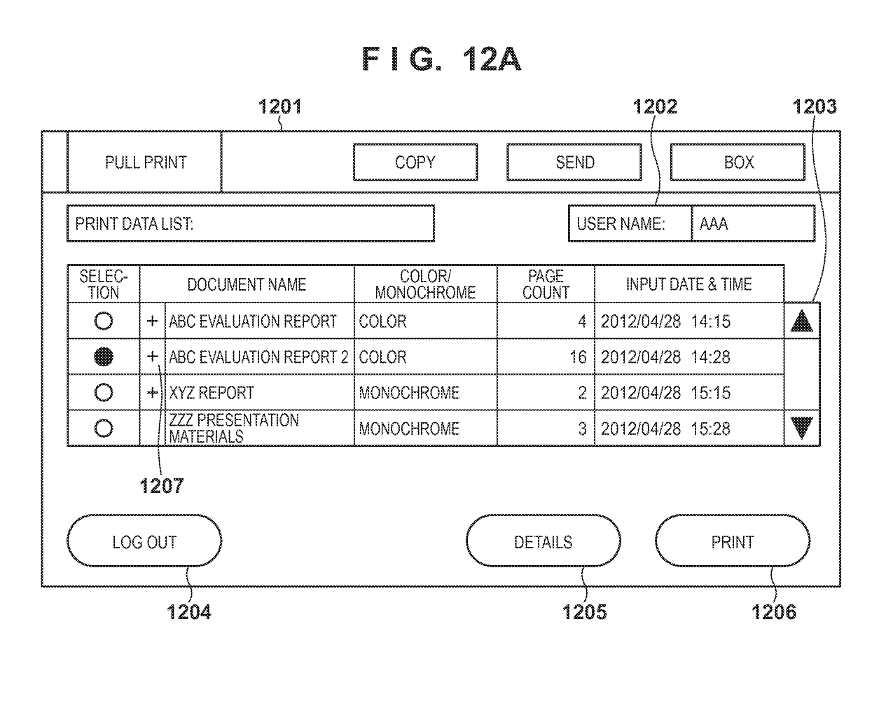

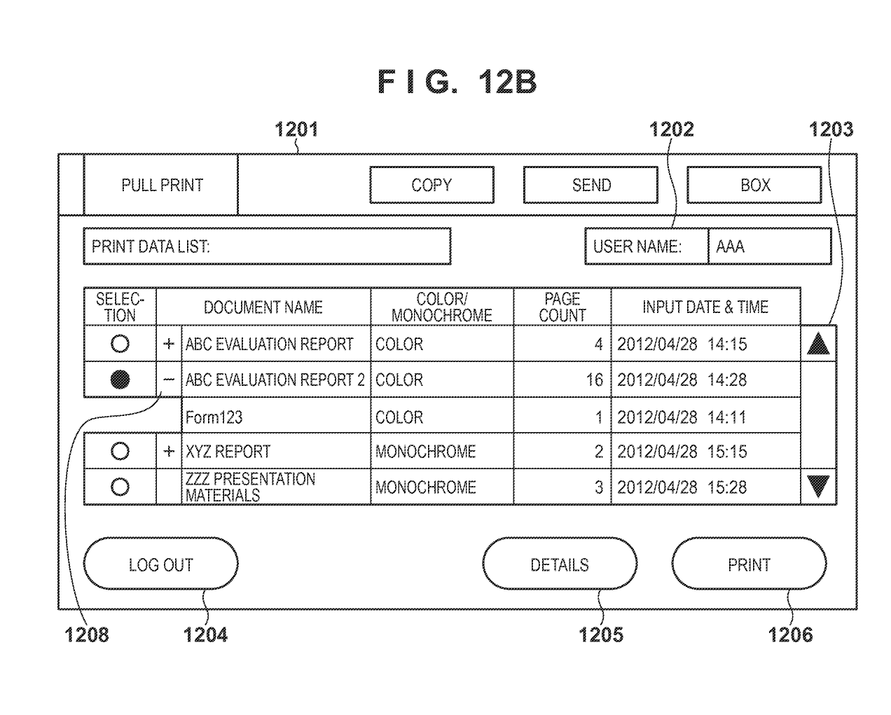

FIGS. 12A and 12B are views showing examples of a print data list screen displayed by the image processing apparatus 101. In FIGS. 12A and 12B, a print data list screen 1201 displays an authenticated user name 1202 and print data list 1203. In addition to the print data list 1203, a “details” button 1205 for instructing display of detailed information for selected job data, and a “print” button 1206 for instructing printout are displayed. A “log out” button 1204 can be used to release the authentication state, cancel pull print processing, and return to a normal screen.

The print data list 1203 displays the following kinds of information:
“document name” for identifying job data acquired from the bibliographic information list 1100
“color/monochrome information” contained in job data
“total page count” when outputting job data
“input time” registered in the server 103

In this example, job data of a document name “ABC evaluation report 2” is selected by a selection check box. When there is an associated form registration job in the bibliographic information list 1100 for each job data, a mark “+” 1207 and mark “−” 1208 representing the presence/absence of a form are displayed. In the initial state of the print data list screen 1201, only the form presence/absence mark “+” 1207 is displayed as shown in FIG. 12A.

When the user presses the form presence/absence mark “+” 1207, the display of the form presence/absence mark is changed to the “−” 1208 as shown in FIG. 12B, and an associated form registration job (in this case, “Form123”) is displayed.

With this setting, the user can identify job data by “document name” and instruct execution of printing without regard to a form registration job or form execution job. When the user presses the “details” button 1205, a detailed information display screen may be displayed so that he can confirm a form registration job associated with selected job data. When the same registration form ID is used for a plurality of job data in the bibliographic information list 1100, each form registration job may be previewed on the detailed information display screen to allow the user to select a target form registration job.

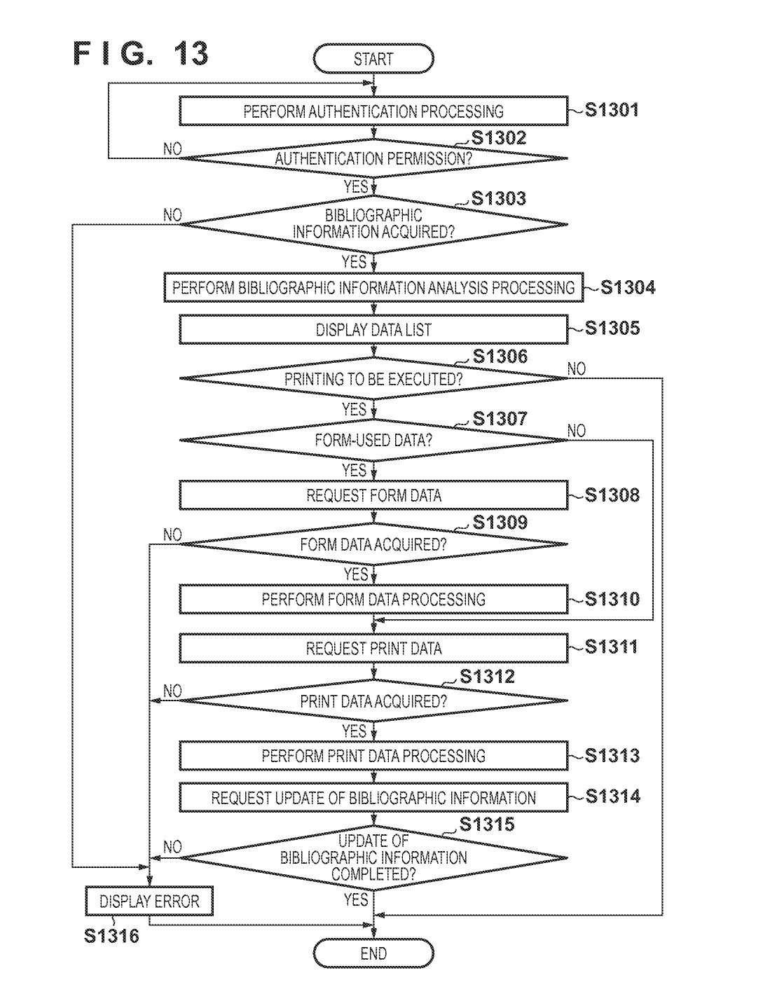

FIG. 13 is a flowchart showing the procedures of pull print processing (printing control) in the image processing apparatus 101. This flowchart is implemented by executing a program stored in the ROM 202 by the CPU 201. The user registers job data in the server 103 from the information processing apparatus 102, then moves to the image processing apparatus 101, and executes user authentication, as shown in FIG. 6. After the user authentication is performed, the print data list screen 1201 displays the authenticated user name 1202 and print data list 1203, as described with reference to FIGS. 12A and 12B. The user selects print data to undergo execution of printing, and instructs the start of printing.

If the operation unit 514 accepts the start of pull print from the user, it notifies the control unit 515 to start an operation. Upon receiving the operation start notification, the control unit 515 instructs the operation unit 514 to display an authentication input screen, and the process shifts to a state in which input of authentication from the user is waited for. If the user inputs authentication information based on a user name and password, the operation unit 514 notifies the control unit 515 of the input authentication information. The control unit 515 generates an authentication request from the notified authentication information, and transmits the authentication request to the server 103 via the communication unit 513 (step S1301).

The control unit 515 receives an authentication result from the server 103 via the communication unit 513 and determines the received authentication result (step S1302). If the authentication result is rejection, the control unit 515 notifies the operation unit 514 of an error. Upon receiving the error notification, the operation unit 514 erases the input user name and password, and the control unit 515 shifts again to the authentication input waiting state. If the authentication result is permission, the control unit 515 receives a bibliographic information list from the server 103 via the communication unit 513 (step S1303).

If the bibliographic information list has not been received normally, the control unit 515 notifies the operation unit 514 of an error. Upon receiving the error notification, the operation unit 514 displays the error, and the pull print processing ends (step S1316). If the bibliographic information list has been received normally, the document list control unit 523 identifies job data having a form presence/absence flag “present” from the bibliographic information list. Then, the document list control unit 523 associates a form registration job and form execution job based on a registration form ID and execution form ID, thereby generating a print data list to be displayed (step S1304).

Thereafter, the control unit 515 notifies the operation unit 514 of the print data list to be displayed, and instructs it to display the print data list shown in FIGS. 12A and 12B. Upon receiving the print data list display instruction, the operation unit 514 displays the print data list as shown in FIGS. 12A and 12B, and the process shifts to a state in which input of an operation instruction from the user is waited for (step S1305). If the user inputs an operation instruction, the operation unit 514 notifies the control unit 515 of the input operation instruction. Upon receiving the operation instruction notification, the control unit 515 confirms the notified operation instruction (step S1306).

If the operation instruction for job data is a printout instruction by pressing the “print” button 1206 in FIGS. 12A and 12B, the control unit 515 confirms whether the selected job data is a form execution job (step S1307). If the control unit 515 determines that the selected job data is a form execution job, it issues a data transmission request for associated form registration job data to the bibliographic information server 103 via the communication unit 513 (step S1308).

After that, the control unit 515 confirms whether the designated form registration job data has been received from the server 103 via the communication unit 513 (step S1309). If the control unit 515 determines that the designated form registration job data has not been received normally, it notifies the operation unit 514 of an error. Upon receiving the error notification, the operation unit 514 displays the error, and the pull print processing ends (step S1316).

If the control unit 515 determines that the designated form registration job data has been received normally, it controls the PDL data analysis unit 519 to generate intermediate data from the received form registration job data. The job data save unit 522 temporarily saves the generated intermediate data (step S1310).

The control unit 515 issues a data transmission request for form execution job data to the server 103 via the communication unit 513 (step S1311). The control unit 515 confirms whether the designated form execution job data has been received from the server 103 via the communication unit 513 (step S1312). If the control unit 515 determines that the designated form execution job data has not been received normally, it notifies the operation unit 514 of an error. Upon receiving the error notification, the operation unit 514 displays the error, and the pull print processing ends (step S1316).

If the designated form execution job data has been received normally, the control unit 515 controls the PDL data analysis unit 519 to generate intermediate data from the received form execution job data. The job data save unit 522 temporarily saves the generated intermediate data. The control unit 515 controls the data rendering unit 520 to composite the temporarily saved form intermediate data and print intermediate data, and convert the composited data into an output image. The output control unit 521 and printing unit 516 perform form printout of the received job data (step S1313).

Since the printout of the received form execution job data is completed, the control unit 515 transmits a bibliographic information update request to the server 103 via the communication unit 513 (step S1314). The control unit 515 confirms, from the server 103 via the communication unit 513, whether bibliographic information of the designated form execution job data has been updated (step S1315). If the update of the bibliographic information of the designated form execution job data has not been received normally, the control unit 515 notifies the operation unit 514 of an error. Upon receiving the error notification, the operation unit 514 displays the error, and the pull print processing ends (step S1316).

As described above, the image processing apparatus 101 can associate form registration data and form execution data based on a bibliographic information list from the server 103, and perform print processing in a correct order.

### Second Embodiment

In the first embodiment, the server 103 reads out form information from document information of job data received from the information processing apparatus 102, and registers it in the bibliographic information list. In the second embodiment, a server 103 analyzes PDL data of received job data to determine whether the PDL data is form data. Then, the server 103 generates form information for job data containing no document information, and registers it in a bibliographic information list.

FIG. 14 is a block diagram showing the software arrangement of the server 103 in the second embodiment. As shown in FIG. 14, the server 103 in the second embodiment further includes a PDL data analysis unit 1401 and document information generation unit 1402. The PDL data analysis unit 1401 analyzes each command of PDL data to determine which of form registration data, form execution data, and form-unused data is the PDL data. The document information generation unit 1402 generates document information based on the determination result of the PDL data analysis unit 1401.

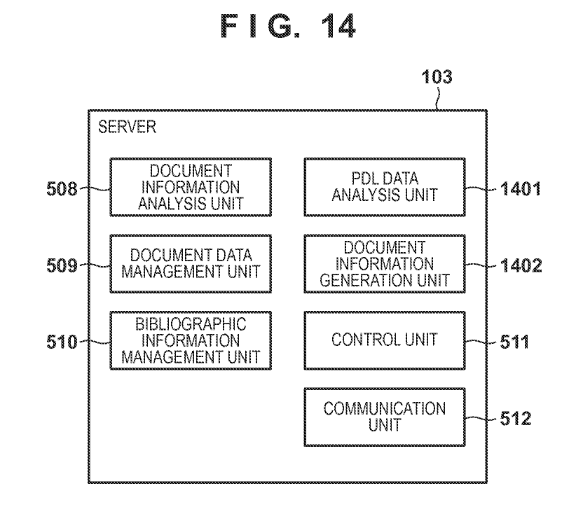

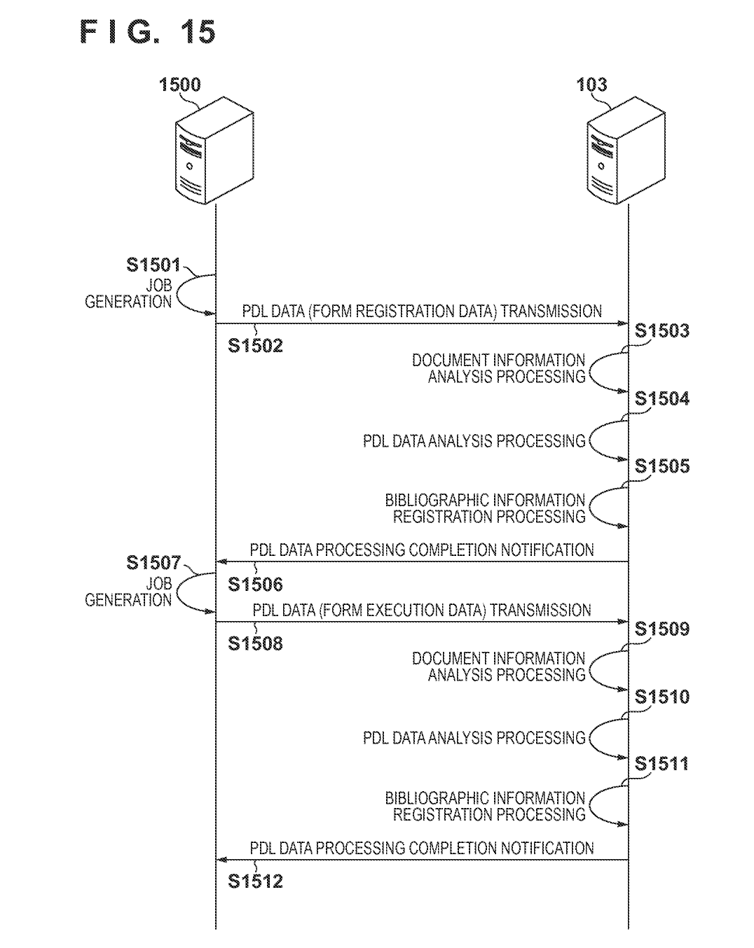

FIG. 15 is a sequence chart showing enterprise job data registration processing in the server 103 in the second embodiment. An enterprise print server 1500 (to be also referred to as an enterprise server) generates job data as PDL data containing no document information. In the enterprise print server 1500, the server 103 is registered as an output print server.

The enterprise print server 1500 generates PDL data as form registration data (step S1501). The enterprise print server 1500 transmits the generated PDL data to the server 103 (step S1502). If the server 103 receives job data from the enterprise print server 1500, a document information analysis unit 508 determines whether the received job data contains document information (step S1503). If the server 103 determines that the received job data does not contain document information, the PDL data analysis unit 1401 analyzes each PDL command of the job data (step S1504). In the server 103, the document information generation unit 1402 generates document information based on the determination result of the PDL data analysis unit 1401. A bibliographic information management unit 510 registers bibliographic information from the generated document information. A document data management unit 509 registers the received job data (step S1505). Then, the server 103 transmits a PDL data processing completion notification to the enterprise print server 1500 (step S1506).

The enterprise print server 1500 generates PDL data as form execution data (step S1507). The enterprise print server 1500 transmits the generated PDL data to the server 103 (step S1508). If the server 103 receives the job data from the enterprise print server 1500, the document information analysis unit 508 determines whether the received job data contains document information (step S1509). If the server 103 determines that the received job data does not contain document information, the PDL data analysis unit 1401 analyzes each PDL command of the job data (step S1510). In the server 103, the document information generation unit 1402 generates document information based on the determination result of the PDL data analysis unit 1401. The bibliographic information management unit 510 registers bibliographic information from the generated document information. Also, the document data management unit 509 registers the received job data (step S1511). Then, the server 103 transmits a PDL data processing completion notification to the enterprise print server 1500 (step S1512).

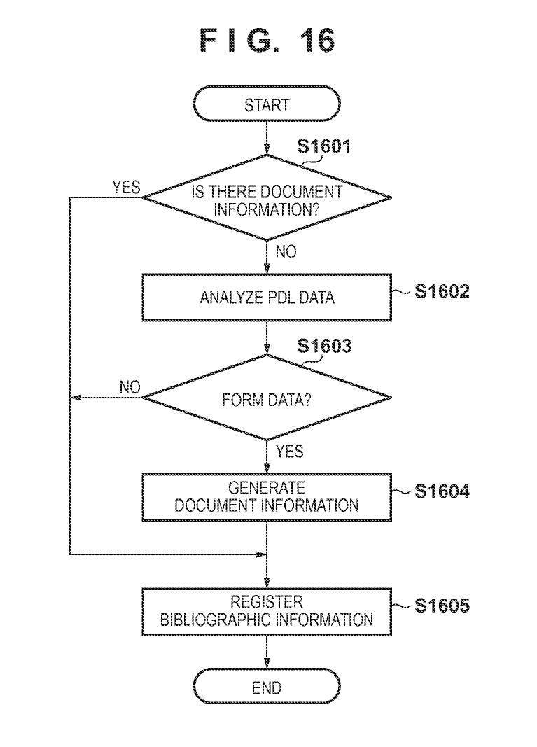

FIG. 16 is a flowchart showing the procedures of enterprise job data registration processing in the server 103 in the second embodiment. This flowchart is implemented by executing a program stored in a ROM 302 by a CPU 301. The document information analysis unit 508 determines whether received job data contains document information (step S1601).

If the document information analysis unit 508 determines that the received job data does not contain document information, the PDL data analysis unit 1401 analyzes each PDL command of the job data (step S1602). Then, the PDL data analysis unit 1401 determines which of form registration data, form execution data, and form-unused data is the job data (step S1603).

If the job data is form registration data or form execution data, the PDL data analysis unit 1401 notifies the document information generation unit 1402 of a form ID, and form registration information or form execution information. The document information generation unit 1402 generates document information (step S1604). The bibliographic information management unit 510 registers bibliographic information in the bibliographic information list from the document information (step S1605).

FIG. 19A is a view showing an example of form registration PDL data generated by the enterprise server 1500 in the second embodiment. In FIG. 19A, page data of respective commands (a page start command 1902, rendering command 1903, and page end command 1904) between a form registration start command 1901 and a form registration end command 1905 are registered as form data. The form registration start command 1901 designates a form ID to be registered.

FIG. 19B is a view showing an example of form execution PDL data generated by the enterprise server 1500 in the second embodiment. In FIG. 19B, a form execution command 1906 designates composite printing of form data with page data of the respective subsequent commands (the page start command 1902, rendering command 1903, and page end command 1904).

As described above, form information can be generated for job data containing no document information, and registered in the bibliographic information list. Here, PDL analysis of job data is performed using the presence/absence of document information as the determination condition. However, whether job data is one from a user having undergone authentication processing may be set as the determination condition, and PDL analysis may be performed for only job data from a user having not undergone authentication processing. This obviates the need to determine whether to perform PDL analysis for each job data, and can increase the processing speed.

### Third Embodiment

In the above-described embodiments, the image processing apparatus 101 specifies a necessary form registration job based on a bibliographic information list from the server 103. The image processing apparatus 101 requests the server 103 to transmit form registration job data. In the third embodiment, a server 103 specifies and transmits a necessary form registration job in accordance with a job data transmission request.

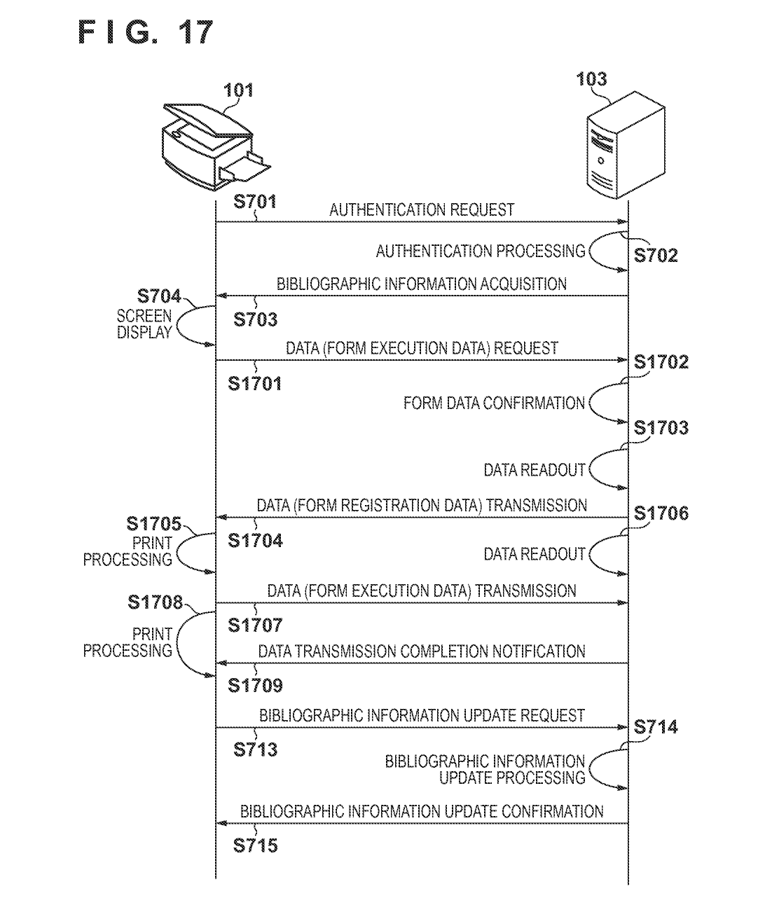

FIG. 17 is a sequence chart showing pull print processing in which form data is simultaneously transmitted in the server 103 in the third embodiment. In FIG. 17, steps S701 to S704 are the same as those in FIG. 7. An image processing apparatus 101 issues a data transmission request for job data to the server 103 via a communication unit 513 (step S1701). At this time, assume that a data transmission request for form execution data is issued without a form registration data output request.

If the server 103 receives the data transmission request for job data from the image processing apparatus 101, a bibliographic information management unit 510 determines whether the job data designated from a bibliographic information list is a form execution job. If the bibliographic information management unit 510 determines that the job data is a form execution job, it searches the bibliographic information list for an associated form registration job (step S1702). In the server 103, a document data management unit 509 reads out the job data detected from the bibliographic information list (step S1703).

If the document data management unit 509 completes the readout of the associated form registration job data, the server 103 transmits the form registration job data to the image processing apparatus 101 via a communication unit 512 (step S1704).

If the image processing apparatus 101 receives the form registration job data from the server 103 via the communication unit 513, a control unit 515 performs print processing for the job data (step S1705). In the server 103, the document data management unit 509 reads out the designated form execution job data (step S1706).

If the document data management unit 509 completes the readout of the designated form execution data, the server 103 transmits the form execution data to the image processing apparatus 101 via the communication unit 512 (step S1707). If the image processing apparatus 101 receives the designated form execution data from the server 103 via the communication unit 513, the control unit 515 performs print processing for the form execution data (step S1708).

The server 103 transmits a designated job data transmission completion notification to the image processing apparatus 101 via the communication unit 512 (step S1709). Subsequent steps 5713 to 5715 are the same as those in FIG. 7.

As described above, the server 103 specifies and transmits a necessary form registration job in accordance with a job data transmission request, and can cause the image processing apparatus 101 to print form registration data and form execution data in a correct order.

### Other Embodiments

In the above-described embodiments, the server 103 may determine in authentication processing whether there is a form registration job in the bibliographic information list. When the server 103 determines that there is an associated form registration job, it may transmit the form registration job in advance to the image processing apparatus 101 without waiting for selection of a form execution job from the user. This obviates the need to request form registration data after selection of a form execution job in the image processing apparatus 101, and can increase the print processing speed.

In the above-described embodiments, the server 103 transmits form registration data or form execution data in accordance with a job data transmission request from the image processing apparatus 101. The server 103 may be configured to be able to control switching of whether to or not to delete job data after transmitting the job data to the image processing apparatus 101, based on which of form registration data and form execution data is data to be transmitted. In this configuration, for example, even after form registration data is transmitted to the image processing apparatus 101, it is not deleted but is left, and can be used again when another image processing apparatus 101 outputs another form execution data. Also, for example, when form execution data is deleted after transmitting it to the image processing apparatus 101, the free area of the HDD 304 can be ensured.

Since the server 103 manages form registration information as bibliographic information, as in the above-described embodiments, the server 103 can perform alternative processing at once, instead of each image processing apparatus 101, for inquiries about the form data registration situation from the information processing apparatus 102 and enterprise server 1500. Since the server 103 manages form registration information as bibliographic information, the information processing apparatus 102 or enterprise server 1500 need not transmit registered form registration data to each image processing apparatus 101 in printing.

The server 103 may process a registered form deletion instruction based on a PDL command from the enterprise print server 1500. Hence, print processing in the enterprise server 1500 which does not perform authentication processing for the pull print system can be executed in a conventional manner.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-088877, filed Apr. 19, 2013, which is hereby incorporated by reference herein in its entirety.

What is claimed is:

1. A printing system comprising:
a holding unit configured to associate print data with form data and hold the print data and the form data;
an acceptance unit configured to accept an instruction to print the print data; and
a print control unit configured to, in a case where said acceptance unit accepts the instruction, control to register the form data and then execute printing of the print data.

2. The system according to claim 1, wherein
the printing system comprises a server and an image processing apparatus, and
a transmission unit of said server transmits the form data to said image processing apparatus in accordance with a request from said image processing apparatus, and transmits the print data to said image processing apparatus.

3. The system according to claim 2, wherein said image processing apparatus further includes:
an acquisition unit configured to acquire, from said server, a list of the print data held by said holding unit of said server; and
a display unit configured to display the list of the print data acquired by said acquisition unit together with the respective associated form data.

4. The system according to claim 1, wherein said server further includes a determination unit configured to determine whether print data received from an information processing apparatus uses form data.

5. The system according to claim 4, wherein the information processing apparatus further includes a generation unit configured to generate the print data and the form data in association with each other.

6. The system according to claim 2, wherein
said image processing apparatus further includes an authentication unit configured to perform user authentication, and
when the instruction is accepted after the user authentication by said authentication unit, said image processing apparatus requests the print data of said server.

7. A printing control method to be executed in a printing system, a server comprising:
a holding step of associating print data with form data and holding the print data and the form data;
an acceptance step of accepting an instruction to print the print data; and
a print control step of, in a case where the instruction is accepted in the acceptance step, controlling to register the form data and then execute printing of the print data.

8. A server in a printing system including the server, an information processing apparatus configured to generate a print job and register the print job in the server, and an image processing apparatus configured to accept an instruction to execute the print job, acquire print data from the server, and execute printing, comprising:
a holding unit configured to associate print data with form data and hold the print data and the form data.

9. An information processing apparatus in a printing system including a server, the information processing apparatus configured to generate a print job and register the print job in the server, and an image processing apparatus configured to accept an instruction to execute the print job, acquire print data from the server, and execute printing, comprising:
a generation unit configured to generate, in association with each other, the print data and the form data for executing form printing by performing a composition with the print data; and
a registration unit configured to register, in the server, the print data and the form data generated by said generation unit.

10. An image processing apparatus in a printing system including a server, an information processing apparatus configured to generate a print job and register the print job in the server, and the image processing apparatus configured to accept an instruction to execute the print job, acquire print data from the server, and execute printing, comprising:
an acceptance unit configured to accept an instruction to print the print data; and
a print control unit configured to, in a case where said acceptance unit accepts the instruction, control to register the form data and then execute printing of the print data.

11. A printing control method to be executed in a server in a printing system including the server, an information processing apparatus configured to generate a print job and register the print job in the server, and an image processing apparatus configured to accept an instruction to execute the print job, acquire print data from the server, and execute printing, comprising:
a holding step of associating print data with form data and holding the print data and the form data.

12. A printing control method to be executed in an information processing apparatus in a printing system including a server, the information processing apparatus configured to generate a print job and register the print job in the server, and an image processing apparatus configured to accept an instruction to execute the print job, acquire print data from the server, and execute printing, comprising:
a generation step of generating, in association with each other, the print data and the form data for executing form printing by performing a composition with the print data; and
a registration step of registering, in the server, the print data and the form data generated in the generation step.

13. A printing control method to be executed in an image processing apparatus in a printing system including a server, an information processing apparatus configured to generate a print job and register the print job in the server, and the image processing apparatus configured to accept an instruction to execute the print job, acquire print data from the server, and execute printing, comprising:
an acceptance step of accepting an instruction to print the print data; and
a print control step of, in a case where the instruction is accepted in the acceptance step, controlling to register the form data and then execute printing of the print data.

14. A computer-readable storage medium storing a program for causing a computer to execute in a server:
a holding step of associating print data with form data and holding the print data and the form data;
an acceptance step of accepting an instruction to print the print data; and
a print control step of, in a case where the instruction is accepted in the acceptance step, controlling to register the form data and then execute printing of the print data.

15. A computer-readable storage medium storing a program for causing a computer to execute in a server in a printing system including the server, an information processing apparatus configured to generate a print job and register the print job in the server, and an image processing apparatus configured to accept an instruction to execute the print job, acquire print data from the server, and execute printing:
a holding step of associating print data with form data and holding the print data and the form data.

16. A computer-readable storage medium storing a program for causing a computer to execute in an information processing apparatus in a printing system including a server, the information processing apparatus configured to generate a print job and register the print job in the server, and an image processing apparatus configured to accept an instruction to execute the print job, acquire print data from the server, and execute printing:
a generation step of generating, in association with each other, the print data and the form data for executing form printing by performing a composition with the print data; and
a registration step of registering, in the server, the print data and the form data generated in the generation step.

17. A computer-readable storage medium storing a program for causing a computer to execute in an image processing apparatus in a printing system including a server, an information processing apparatus configured to generate a print job and register the print job in the server, and the image processing apparatus configured to accept an instruction to execute the print job, acquire print data from the server, and execute printing:
an acceptance step of accepting an instruction to print the print data; and
a print control step of, in a case where the instruction is accepted in the acceptance step, controlling to register the form data and then execute printing of the print data.
